(19) United States
(12) Patent Application Publication
(10) Pub. No.: US 2006/0236771 A1
(43) Pub. Date: Oct. 26, 2006

(54) Vibration and rotation detector

(76) Inventor: Dong-Chang Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/114,042

(22) Filed: Apr. 26, 2005

(51) Int. Cl. G01N 29/04

(52) U.S. Cl. 73/649

(57) ABSTRACT

The invention relates to a vibration and rotation detector, which includes a main body with control buttons and a panel. The main body has its one end connect with a rotation probe and the other end a vibration probe that obtains double functions in one single detector. Hence, the detector can detect different environment factors more easily and efficiently.

### FIELD OF THE INVENTION

The present invention relates to a vibration and rotation detector, which can detect environment factors including vibration, acceleration, speed, movement, or rotation directly.

### BACKGROUND OF THE INVENTION

As shown in FIG. 1, it shows a conventional rotation detector, which includes a main body (1) and a rotating probe (11) for detecting rotation speed of other objects. In FIG. 2, it is a traditional vibration detector, which includes a main body (2) connecting with a wire (21). A vibrate probe (22) connected with the other end of the wire (21) is provided for detecting the vibration factors (such as acceleration, speed, and movement) of another object. Each of the above-mentioned detectors is with only one function. If one needs to detect different environment factors, he must bring two different detectors that will be trouble and inconvenient.

### SUMMARY OF THE INVENTION

The present invention is to provide a vibration and rotation detector, which can provided double functions with only one main body that facilitates the use for people. Now, accompanying with the following drawings, the character of the present invention will be described here and after.

### BRIEF DESCRIPTION OF THE DRAWINGS

FIG. 1 is a plan view showing a conventional rotation detector.

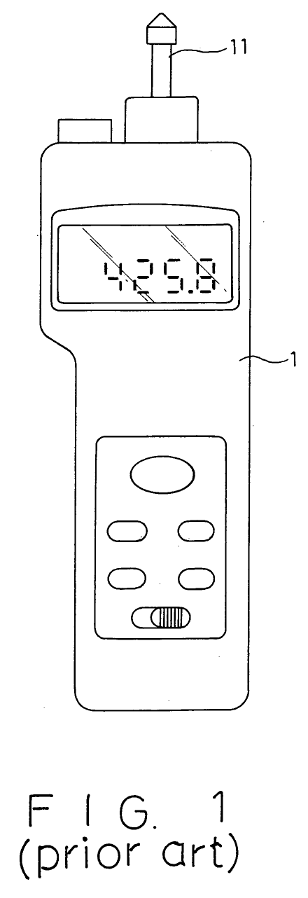

FIG. 2 is a plan view showing a conventional vibration detector.

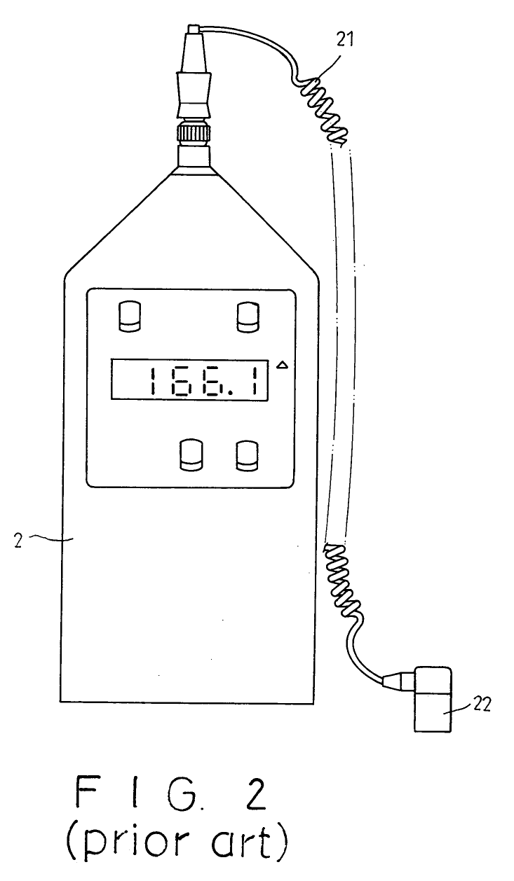

FIG. 3 is an exploded perspective view showing a vibration and rotation detector according to the present invention.

### DETAILED DESCRIPTION OF THE PREFERRED EMBODIMENT

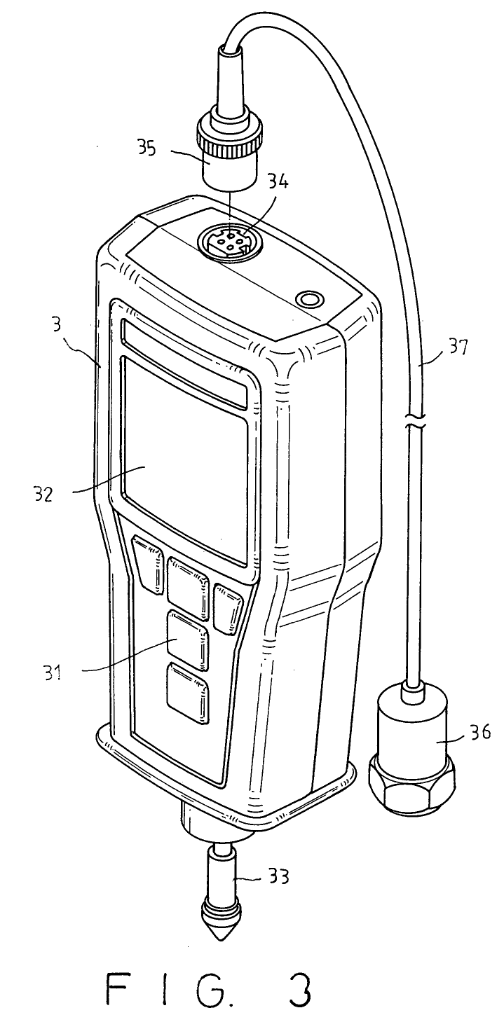

Please refer to FIG. 3, the present invention relates to an improvement of an environment detector for detecting environment factors more conveniently. The invention includes a two-in-one main body (3), which is provided with some buttons (31) and a panel (32). An optical or contact rotation probe (33) is provided on one end and an aperture (34) is formed on the other end for connecting with a joint (35). A vibration probe (36) is connected with the joint (35) by a wire (37).

When to detect vibration factors including acceleration, speed, and movement of an object in environment, the vibration probe (36) can be placed directly therein. The user can control buttons (31) on the main body (3) and reads all data from panel (32). When to detect the rotating data, the rotation probe (33) can be placed directly above the object and the information is obtained easily.

If the detector is not going to be used, the joint (35) with the wire (37) and the probe (36) can be separated from the main body (3). Hence, the detector will be easier to be carried or packaged. On the other hand, the vibration probe (36) is capable of being fixed on the main body. Accordingly, the present invention is obviously utilized and effective. It should be allowed for patent.

I claim:

1. A vibration and rotation detector including a two-in-one main body, which is provided with an optical or contact rotation probe on one end and an aperture on the other end for engaging with a joint connecting with a wire and an end vibration probe.

2. A vibration and rotation detector as claimed in claim 1, wherein the aperture is formed on a side of the main body.

3. A vibration and rotation detector as claimed in claim 1, wherein the vibration probe is fixed on the main body.
